(19) United States
(12) Patent Application Publication
(10) Pub. No.: US 2012/0306861 A1
(43) Pub. Date: Dec. 6, 2012

(54) LIGHT SOURCE DEVICE AND DISPLAY

(75) Inventor: Masaru Minami, Kanagawa (JP)

(73) Assignee: Sony Corporation, Tokyo (JP)

(21) Appl. No.: 13/472,623

(22) Filed: May 16, 2012

(30) Foreign Application Priority Data
Jun. 6, 2011 (JP) 2011-126087

(51) Int. Cl. G06T 15/00; F21V 13/12; G09F 13/18; F21V 13/02

(52) U.S. Cl. 345/419; 362/606; 362/602

(57) ABSTRACT

A light source device includes: a light guide plate having a first internal reflection face and a second internal reflection face opposed to each other; a first light source applying first illumination light into the light guide plate through a side face thereof; and a plurality of scattering regions provided, inside the light guide plate, between the first internal reflection face and the second internal reflection face, the scattering regions allowing the first illumination light to be scattered and to exit from the first internal reflection face to outside of the light guide plate.

### BACKGROUND

The present disclosure relates to a light source device and a display enabling stereoscopic display utilizing a parallax barrier system.

A stereoscopic display of a parallax barrier type is one of typical stereoscopic display systems enabling stereoscopic display with naked eyes without wearing special glasses. The stereoscopic display includes a parallax barrier disposed to face a two-dimensional display panel on the front (on the display surface side) of the two-dimensional display panel. The parallax barrier typically has a structure where light-shielding portions shielding display image light from the two-dimensional display panel and stripe-shaped openings (slit portions) transmitting the display image light are alternately provided in a horizontal direction.

In the parallax barrier system, parallax images for stereoscopy (in the case of two perspectives, a right perspective image and a left perspective image) are displayed on the two-dimensional display panel in a space-divisional manner, and the parallax images are parallactically separated, in a horizontal direction, by the parallax barrier for stereoscopy. The width of each slit of the parallax barrier is appropriately set. This enables light rays of different parallax images to be separately incident on two eyes of a viewer through the slit portions in viewing of the stereoscopic display from a predetermined position and a predetermined direction by the viewer.

It is to be noted that, in the case where, for example, a transmissive liquid crystal display panel is used as the two-dimensional display panel, the parallax barrier is allowed to be disposed on the back side of the two-dimensional display panel (see FIG. 10 of Japanese Patent No. 3565391 and FIG. 3 of Japanese Unexamined Patent Application Publication No. 2007-187823). In such a case, the parallax barrier is disposed between the transmissive liquid crystal display panel and a backlight.

### SUMMARY

Unfortunately, the stereoscopic display utilizing a parallax barrier system includes a special component for three-dimensional display, or the parallax barrier, leading to a large number of components and a wide layout space compared with typical displays for two-dimensional display.

It is desirable to provide a light source device and a display including a light guide plate allowing a function equivalent to the parallax barrier to be achieved.

A light source device according to an embodiment of the disclosure includes: a light guide plate having a first internal reflection face and a second internal reflection face opposed to each other; a first light source applying first illumination light into the light guide plate through a side face thereof; and a plurality of scattering regions provided, inside the light guide plate, between the first internal reflection face and the second internal reflection face, the scattering regions allowing the first illumination light to be scattered and to exit from the first internal reflection face to outside of the light guide plate.

A display according to a first viewpoint of an embodiment of the disclosure includes: a display section displaying image; and a light source device emitting light for image display to the display section. The light source device includes: a light guide plate having a first internal reflection face and a second internal reflection face opposed to each other; a first light source applying first illumination light into the light guide plate through a side face thereof; and a plurality of scattering regions provided, inside the light guide plate, between the first internal reflection face and the second internal reflection face, the scattering regions allowing the first illumination light to be scattered and to exit from the first internal reflection face to outside of the light guide plate.

A display according to a second viewpoint of the embodiment of the disclosure includes: a display section displaying image; and a light source device emitting light for image display to the display section. The light source device includes: a light guide plate having a first internal reflection face and a second internal reflection face opposed to each other; a first light source applying first illumination light into the light guide plate through a side face thereof; a support provided between the light guide plate and the display section; and a plurality of scattering regions provided on one or both of the first and second internal reflection faces, the scattering regions allowing the first illumination light from the first light source to be scattered and to exit from the first internal reflection face to outside of the light guide plate.

A display according to an embodiment of the disclosure includes: a display section; and a light source device including a light guide plate, a first light source, and a second light source. The light guide plate has a first face and a second face opposed to each other and includes a plurality of scattering regions provided between the first and second faces. The first light source is disposed to face a side of the light guide plate. The second light source is disposed to face a second side of the light guide plate. The display section is disposed to face the first face, and has a first display mode and a second display mode. The first light source is controlled to stay lit whereas the second light source is controlled to stay unlit, in the first display mode. The second light source is controlled to stay lit in the second display mode.

In the light source device or the display according to the embodiment of the disclosure, the first illumination light from the first light source is scattered by the scattering regions, and part or all of the scattered light is allowed to exit from the first internal reflection face to the outside of the light guide plate. This allows the light guide plate itself to function as the parallax barrier. Specifically, the light guide plate equivalently functions as the parallax barrier with the scattering regions as the openings (slit portions).

According to the light source device or the display according to the embodiment of the disclosure, scattering regions are provided in the light guide plate, and thus the light guide plate itself is allowed to equivalently function as the parallax barrier.

In particular, according to the display according to the first viewpoint of the embodiment of the disclosure, scattering regions are provided inside the light guide plate, and thus, it is easier to adequately maintain a distance between a plurality of scattering regions corresponding to a parallax barrier and the display section.

In addition, according to the display according to the second viewpoint of the embodiment of the disclosure, the support is provided between the light guide plate and the display section, and thus it is easier to adequately maintain a distance between a plurality of scattering regions corresponding to a parallax barrier and the display section.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a sectional view illustrating an exemplary configuration of a display according to a first embodiment of the disclosure together with a state of light rays emitted from a light source device in the case where only first light sources are on (lit).

FIG. 2 is a sectional view illustrating the exemplary configuration of the display shown in FIG. 1 together with a state of light rays emitted from the light source device in the case where only a second light source is on (lit).

FIGS. 3A and 3B are sectional views illustrating an exemplary configuration of a display according to a second embodiment together with a state of light rays emitted from a light source device, where FIG. 3A shows a state of light rays emitted during three-dimensional display, and FIG. 3B shows light rays emitted during two-dimensional display.

FIGS. 4A and 4B are sectional views illustrating an exemplary configuration of a display according to a third embodiment together with a state of light rays emitted from a light source device, where FIG. 4A shows a state of light rays emitted during three-dimensional display, and FIG. 4B shows a state of light rays emitted during two-dimensional display.

FIG. 5 is a sectional view illustrating an exemplary configuration of a display according to a fourth embodiment together with a state of light rays emitted from a light source device in the case where only a first light source is on (lit).

FIG. 6A is a sectional view illustrating an exemplary configuration of a display according to a fifth embodiment together with a state of light rays emitted from a light source device in the case where only a first light source is on (lit). FIG. 6B is a sectional view illustrating an exemplary configuration of the display shown in FIG. 6A together with a state of light rays emitted from the light source device in the case where only a second light source is on (lit).

FIG. 7A is a plan view illustrating an exemplary correspondence relationship between a pixel structure of a display section and posts in the display shown in FIGS. 6A and 6B, and FIG. 7B is a sectional view of the display.

### DETAILED DESCRIPTION OF EMBODIMENT

Hereinafter, embodiments of the disclosure will be described in detail with reference to the accompanying drawings.

### First Embodiment

[Overall Configuration of Display]

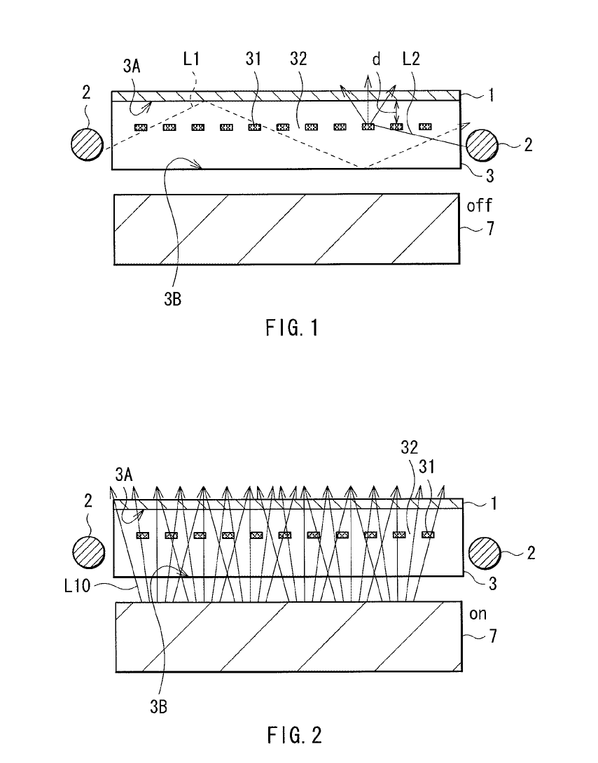

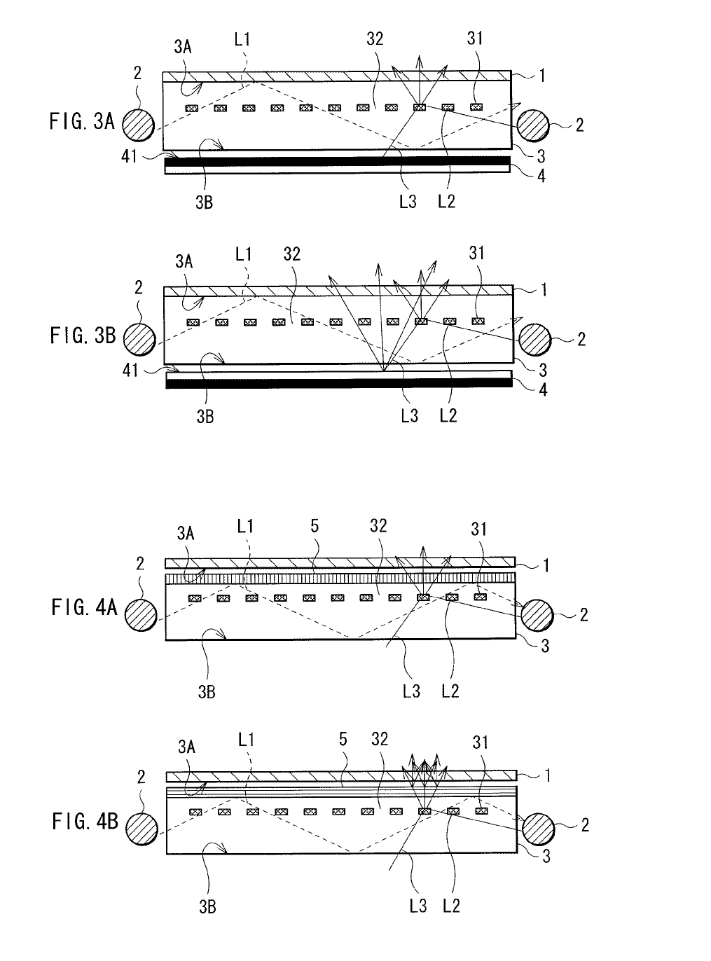

FIGS. 1 and 2 illustrate an exemplary configuration of a display according to a first embodiment of the disclosure. The display includes a display section 1 for image display and a light source device that is disposed on a back of the display section 1 and emits light for image display to the display section 1. The light source device includes first light sources 2 (light sources for two-dimensional (2D) and three-dimensional (3D) display), a light guide plate 3, and a second light source 7 (light source for 2D display). The light guide plate 3 has a first internal reflection face 3A facing the display section 1 and a second internal reflection face 3B facing the second light source 7. It is to be noted that, while the display includes other display components such as a control circuit for the display section 1, description of them is omitted because they have configurations similar to those of typical components such as a typical display control circuit. The light source device further includes an undepicted control circuit that controls each of the first light sources 2 and the second light source 7 to be on (lit) or off (unlit).

The display is allowed to be appropriately and selectively switched between a full-screen two-dimensional (2D) display mode and a full-screen three-dimensional (3D) display mode. The switching between the two-dimensional display mode and the three-dimensional display mode is enabled through switching control of image data displayed on the display section 1 and on/off switching control of each of the first light sources 2 and the second light source 7. FIG. 1 schematically illustrates a state of light rays emitted from the light source device in the case where only the first light sources 2 are on (lit), which corresponds to the three-dimensional display mode. FIG. 2 schematically illustrates a state of light rays emitted from the light source device in the case where only the second light source 7 is on (lit), which corresponds to the two-dimensional display mode.

The display section 1 includes a transmissive two-dimensional display panel, for example, a transmissive liquid crystal display panel, and has a plurality of pixels arranged in a matrix, each including a red (R) pixel, a green (G) pixel, and a blue (B) pixel, for example. The display section 1 modulates light from the light source device for each of the pixels depending on image data for two-dimensional image display. The display section 1 displays a plurality of perspective images based on three-dimensional image data and an image based on two-dimensional image data in an appropriately and selectively switched manner. It is to be noted that the three-dimensional image data refers to, for example, data including a plurality of perspective images corresponding to a plurality of viewing angle directions in three-dimensional display. For example, in the case of two-eye-type three-dimensional display, the three-dimensional image data correspond to, for example, perspective image data for right-eye display and for left-eye display. For example, a composite image configured of a plurality of perspective images arranged in a stripe form in one screen is formed and displayed for display in the three-dimensional display mode.

The first light source 2 includes, for example, a fluorescent lamp such as a cold cathode fluorescent lamp (CCFL) or a light emitting diode (LED). The first light source 2 applies first illumination light L1 and L2 (FIG. 1) to into the light guide plate 3 from a side face thereof. One or more first light sources 2 are disposed on side faces of the light guide plate 3. For example, if the light guide plate 3 has a rectangular planar shape having four side faces, one or more first light sources 2 may be disposed on one or more of the side faces. FIG. 1 illustrates an exemplary configuration where the first light sources 2 are disposed on two opposed side faces of the light guide plate 3. Each of the first light sources 2 is controlled to be on (lit) or off (unlit) in response to switching modes between the two-dimensional display mode and the three-dimensional display mode. In detail, the first light source 2 is controlled to stay lit for image display on the display section 1 based on the three-dimensional image data (in the case of three-dimensional display mode), and controlled to stay unlit or lit for image display on the display section 1 based on the two-dimensional image data (in the case of two-dimensional display mode).

The second light source 7 is disposed to face the second internal reflection face 3B of the light guide plate 3. The second light source 7 externally applies second illumination light L10 to the second internal reflection face 3B (see FIG. 2). Any planar light source that emits light having uniform in-plane luminance, such as a commercially available planar backlight, may be used as the second light source 7 without any structural limitation. Examples of the structure include a light emitting body such as CCFL and LED, and a light diffuser plate allowing uniform in-plane luminance. The second light source 7 is controlled to be on (lit) or off (unlit) in response to switching modes between the two-dimensional display mode and the three-dimensional display mode. In detail, the second light source 7 is controlled to stay unlit for image display on the display section 1 based on the three-dimensional image data (in the case of three-dimensional display mode), and controlled to stay lit for image display on the display section 1 based on the two-dimensional image data (in the case of two-dimensional display mode).

The light guide plate 3 is disposed in contact with the back of the display section 1. The light guide plate 3 includes, for example, a transparent plastic plate such as acrylic resin. Surfaces of the light guide plate 3 are entirely transparent. For example, if the light guide plate 3 has a rectangular planar shape, the first internal reflection face 3A, the second internal reflection face 3B, and the four side faces are entirely transparent.

The first internal reflection face 3A and the second internal reflection face 3B are entirely mirror-finished, and thus each reflection face internally and totally reflects light rays incident at an angle that satisfies a total reflection condition inside the light guide plate 3, and emits light rays that do not satisfy the total reflection condition to the outside.

A plurality of scattering regions 31 are provided between the first internal reflection face 3A and the second internal reflection face 3B inside the light guide plate 3. As shown in FIG. 1, the scattering regions 31 scatter-reflect the first illumination light L2 from the first light source 2, and allow part or all of the first illumination light L2 as light rays, which do not satisfy the total reflection condition, to exit through the first internal reflection face 3A to the outside of the light guide plate 3.

The scattering regions 31 are formed inside the light guide plate 3 by the following process using a laser, for example. Specifically, when a laser beam having a high peak value (second harmonic) is concentrated to the inside of a transparent material such as glass and acrylic resin, light absorption abruptly increases through a multiphoton absorption process, leading to occurrence of cracks within the material. According to such a principle, the inside of the transparent material is carved into various shapes.

The scattering regions 31 function as the openings (slit portions) of the parallax barrier system in the three-dimensional display mode (in the case where only the first light sources 2 are lit). The scattering regions 31 are therefore arranged in a predetermined direction at an interval so as to have a structure corresponding to the openings of the parallax barrier. The regions between adjacent scattering regions 31 act as transmission regions 32. It is to be noted that examples of the barrier pattern of the parallax barrier corresponding to the arrangement pattern of the scattering regions 31 include various types of patterns without any limitation, for example, a stripe-shaped pattern where a large number of elongated slit-like openings are horizontally arranged in parallel with light-shielding portions therebetween.

In the display shown in FIG. 1, pixels of the display section 1 and the scattering regions 31 of the light guide plate 3 need to be disposed to face each other with a predetermined distance d therebetween for spatial separation of the plurality of perspective images displayed on the display section 1. In the embodiment, since the scattering regions 31 are provided within the light guide plate 3, the predetermined distance d is stably maintained only by disposing the light guide plate 3 in contact with the back of the display section 1.

[Operation of Display]

In the display, for display in the three-dimensional display mode, the display section 1 displays images based on three-dimensional image data, and the first light sources 2 and the second light source 7 are each controlled to be on (lit) or off (unlit) for three-dimensional display. In detail, as shown in FIG. 1, the first light sources 2 are controlled to stay on (lit), and the second light source 7 is controlled to stay off (unlit). In this state, the first illumination light L1 from the first light sources 2 is repeatedly and internally total-reflected between the first internal reflection face 3A and the second internal reflection face 3B in the light guide plate 3, thereby the first illumination light L1 is guided from a first side face, on which one of the first light sources 2 is disposed, to an opposite second side face, and is allowed to exit through the second side face. In addition, part of the first illumination light L2 from the first light source 2 is scatter-reflected by the scattering regions 31 of the light guide plate 3 and thus allowed to be transmitted by the first internal reflection face 3A of the light guide plate 3, and to exit to the outside of the light guide plate 3. This allows the light guide plate itself to function as the parallax barrier. Specifically, the light guide plate 3 itself is allowed to equivalently function as the parallax barrier where the scattering regions 31 act as the openings (slit portions) for the first illumination light L2 from the first light source 2. This results in display equivalent to three-dimensional display utilizing the parallax barrier system where the parallax barrier is disposed on the back side of the display section 1.

In contrast, for display in the case of two-dimensional display mode, the display section 1 displays an image based on two-dimensional image data, and each of the first light sources 2 and the second light source 7 is controlled to be on (lit) or off (unlit) for two-dimensional display. In detail, for example, as shown in FIG. 2, the first light sources 2 are controlled to stay off (unlit), and the second light source 7 is controlled to stay on (lit). In this case, the second illumination light L10 from the second light source 7 is transmitted by the transmission regions 32 of the second internal reflection face 3B, and thus, is allowed to exit to the outside of the light guide plate 3 through substantially the entire first internal reflection face 3A as light rays that do not satisfy the total reflection condition. Specifically, the light guide plate 3 functions as a planar light source similar to a typical backlight. This results in display equivalent to three-dimensional display utilizing the backlight system where the backlight is disposed on the back side of the display section 1.

It is to be noted that, although the second illumination light L10 is output from substantially the entire surface of the light guide plate 3 even if only the second light source 7 is lit, the first light sources 2 may be also lit as necessary. Consequently, for example, if luminance distribution is different between the portions corresponding to the scattering regions 31 and the portions corresponding to the transmission regions 32 through lighting of only the second light source 7, the luminance distribution is optimized over the entire surface through appropriate adjustment of a lighting state of the first light sources 2 (on/off control or adjustment of a lighting level). However, in the case of two-dimensional display, for example, if the display section 1 adequately corrects luminance, only the second light source 7 needs to be lit.

[Effect]

As described above, according to the display of the embodiment, the scattering regions 31 are provided within the light guide plate 3, and the first illumination light L1 and L2 from the first light sources 2 and the second illumination light L10 from the second light source 7 are selectively allowed to exit to the outside of the light guide plate 3. As a result, the light guide plate 3 itself equivalently functions as the parallax barrier. Consequently, the number of components is reduced compared with the stereoscopic display utilizing the parallax barrier system in the past, leading to space-saving.

In addition, the scattering regions 31 are provided within the light guide plate 3, and thus it is easier to adequately maintaining the distance d between the scattering regions 31 corresponding to the parallax barrier, and the display section 1. In the stereoscopic display of the parallax barrier type, the distance (gap) between the display panel and the parallax barrier needs to be accurately controlled. The gap is determined depending on design indicia such as pixel size of a display panel, the number of eyepoints for stereoscopic display, and an optimum viewing distance. If the scattering regions 31 are provided on the top surface (the first internal reflection face 3A) or the bottom surface (the second internal reflection face 3B) of the light guide plate 3 instead of in the inside thereof, the following difficulties occur. If the scattering regions 31 are provided on the bottom surface of the light guide plate 3, the gap is controlled with the thickness of the light guide plate 3. However, the thickness of the light guide plate 3 is inconveniently small depending on the design indicia (for example, in the case of a small viewing distance). Such extremely small thickness of the light guide plate 3 leads to a reduction in size of the first light sources 2 disposed on the side faces of the light guide plate 3, and such an extremely reduced size of a light source may be commercially unavailable. On the other hand, if the scattering regions 31 are provided on the top surface of the light guide plate 3, the gap is controlled using another component instead of the thickness of the light guide plate 3. However, a gap-controlling component that is not optically joined to the light guide plate 3 causes reflection at the interface thereof, leading to a reduction in luminance or degradation in display quality. The embodiment overcomes such difficulties through providing the scattering regions 31 inside the light guide plate 3.

### Second Embodiment

A display according to a second embodiment of the disclosure is now described. It is to be noted that substantially the same components as those of the display according to the first embodiment are designated by the same numerals, and description of them is appropriately omitted.

[Overall Configuration of Display]

FIGS. 3A and 3B illustrate an exemplary configuration of a display according to a second embodiment of the disclosure. This display includes an electronic paper 4 in place of the second light source 7 of the display shown in FIGS. 1 and 2.

The display is allowed to be appropriately and selectively switched between a full-screen two-dimensional (2D) display mode and a full-screen three-dimensional (3D) display mode. FIG. 3A schematically illustrates a configuration in the three-dimensional display mode, and FIG. 3B schematically illustrates a configuration in the two-dimensional display mode. FIGS. 3A and 3B each also schematically illustrate a state of light rays emitted from a light source device in each display mode.

The electronic paper 4 is disposed to face the second internal reflection face 3B of the light guide plate 3. The electronic paper 4 is an optical device that is selectively switched in a mode of action on incident light rays between a light absorption mode and a scattering-reflection mode. The electronic paper 4 is configured of a particle-movement-type display such as an electrophoresis type display and a quick-response liquid powder type display. In the particle-movement-type display, for example, positively-charged black particles and negatively-charged white particles are dispersed between a pair of opposed substrates, and the black and white particles are moved depending on a voltage applied between the substrates, thereby achieving black or white display. In particular, the particles are dispersed in a solution in the electrophoresis type display, while the particles are dispersed in a gas in the quick-response liquid powder type display. The above-described light absorption mode corresponds to a full-screen black display state of a display surface 41 of the electronic paper 4 as shown in FIG. 3A. The scattering-reflection mode corresponds to a full-screen white display state of the display surface 41 of the electronic paper 4 as shown in FIG. 3B. In the case where a display section 1 displays a plurality of perspective images based on three-dimensional image data (for the three-dimensional display mode), the electronic paper 4 is switched into the light absorption mode as the action on the incident light rays. In the case where the display section 1 displays an image based on two-dimensional image data (for the two-dimensional display mode), the electronic paper 4 is switched into the scattering-reflection mode as the action on the incident light rays.

[Operation of Display]

In the display, for display in the three-dimensional display mode (FIG. 3A), the display section 1 displays images based on three-dimensional image data, while the display surface 41 of the electronic paper 4 is switched into the full-screen black display state (light absorption mode). In this state, the first illumination light L1 from the first light sources 2 is repeatedly and internally total-reflected between the first internal reflection face 3A and the second internal reflection face 3B in the light guide plate 3, thereby the first illumination light L1 is guided from a first side face, on which one of the first light sources 2 is disposed, to an opposite second side face, and allowed to exit through the second side face. In addition, part of the first illumination light L2 from the first light sources 2 is scatter-reflected by the scattering regions 31 of the light guide plate 3 and thus transmitted by the first internal reflection face 3A of the light guide plate 3, and allowed to exit to the outside of the light guide plate 3. In addition, the scattering regions 31 internally reflect other partial light rays L3, which then enter the display surface 41 of the electronic paper 4 through the second internal reflection face 3B of the light guide plate 3. In this state, the display surface 41 of the electronic paper 4 is in the full-screen black display state; hence, the light rays L3 are absorbed by the display surface 41. As a result, in the light guide plate 3, light rays are emitted from the first internal reflection face 3A only through the portions corresponding to the scattering regions 31. Specifically, the light guide plate 3 itself is allowed to equivalently function as the parallax barrier where the scattering regions 31 act as the openings (slit portions) for the first illumination light L2 from the first light sources 2. This results in display equivalent to three-dimensional display utilizing the parallax barrier system where the parallax barrier is disposed on the back side of the display section 1.

In contrast, for display in the two-dimensional display mode (FIG. 3B), the display section 1 displays an image based on two-dimensional image data, and the display surface 41 of the electronic paper 4 is switched into the full-screen white display state (scattering-reflection mode). In this state, the first illumination light L1 from the first light sources 2 is repeatedly and internally total-reflected between the first internal reflection face 3A and the second internal reflection face 3B in the light guide plate 3, thereby the first illumination light L1 is guided from the first side face, on which one of the first light sources 2 is disposed, to the opposite second side face, and allowed to exit through the second side face. In addition, part of the first illumination light L2 from the first light source 2 is scatter-reflected by the scattering regions 31 of the light guide plate 3 and thus transmitted by the first internal reflection face 3A of the light guide plate 3, and allowed to exit to the outside of the light guide plate 3. In addition, the scattering regions 31 internally reflect other partial light rays L3, which then enter the display surface 41 of the electronic paper 4 through the second internal reflection face 3B of the light guide plate 3. In this state, the display surface 41 of the electronic paper 4 is in the full-screen white display state; hence, the light rays L3 are scatter-reflected by the display surface 41. Such scatter-reflected light rays enter the light guide plate 3 again through the second internal reflection face 3B. An incident angle of such light rays does not satisfy the total reflection condition, and thus the light rays are allowed to exit to the outside of the light guide plate 3. As a result, the light rays are allowed to exit through the entire surface of the first internal reflection face 3A in the light guide plate 3. Specifically, the light guide plate 3 functions as a planar light source similar to a typical backlight. This results in display equivalent to two-dimensional display utilizing the backlight system where the typical backlight is disposed on the back side of the display section 1.

[Effect]

The display of the embodiment principally demonstrates the effects similar to those in the first embodiment though it is different in a configuration from the display of the first embodiment in that the electronic paper 4 is provided in place of the second light source 7 in the display shown in FIGS. 1 and 2.

### Third Embodiment

A display according to a third embodiment of the disclosure is now described. It is to be noted that substantially the same components as those of the display according to the first or second embodiment are designated by the same numerals, and description of them is appropriately omitted.

[Overall Configuration of Display]

FIGS. 4A and 4B illustrate an exemplary configuration of a display according to a third embodiment of the disclosure. The display is allowed to be appropriately and selectively switched between the two-dimensional display mode and the three-dimensional display mode, as in the display shown in FIGS. 1 and 2. FIG. 4A schematically illustrates a configuration in the three-dimensional display mode, and FIG. 4B schematically illustrates a configuration in the two-dimensional display mode. FIGS. 4A and 4B each also schematically illustrate a state of light rays emitted from a light source device in each display mode.

The display includes a polymer diffuser plate 5 in place of the second light source 7 of the display shown in FIGS. 1 and 2. The polymer diffuser plate 5 is formed of polymer-dispersed liquid crystal. The polymer diffuser plate 5 is disposed to face the light guide plate 3 such that, for example, the back of the polymer diffuser plate 5 is in contact with the first internal reflection face 3A. The polymer diffuser plate 5 is an optical device that is allowed to be selectively switched in a mode of action on incident light rays between a transparent mode and a diffusing-transmission mode.

[Operation of Display]

In the display, for display in the three-dimensional display mode (FIG. 4A), a display section 1 displays images based on three-dimensional image data, and the polymer diffuser plate 5 is entirely switched into the transparent mode. In this state, the first illumination light L1 from each first light source 2 is repeatedly and internally total-reflected between the first internal reflection face 3A and the second internal reflection face 3B in the light guide plate 3, thereby the first illumination light L1 is guided from the first side face, on which one of the first light sources 2 is disposed, to the opposite second side face, and allowed to exit through the second side face. In addition, part of the first illumination light L2 from the first light source 2 is scatter-reflected by the scattering regions 31 of the light guide plate 3 and thus transmitted by the first internal reflection face 3A of the light guide plate 3, and allowed to exit to the outside of the light guide plate 3. The light rays exiting to the outside through the scattering regions 31 enter the polymer diffuser plate 5. Here, the polymer diffuser plate 5 is entirely transparent; hence, the light rays directly enter the display section 1 through the polymer diffuser plate 5 at an angle equal to the output angle from the scattering regions 31. In addition, the scattering regions 31 internally reflect other partial light rays L3, which are then allowed to exit to the outside through the second internal reflection face 3B of the light guide plate 3, and thus do not contribute to image display. As a result, light rays are allowed to exit from the first internal reflection face 3A of the light guide plate 3 only through portions corresponding to the scattering regions 31. Specifically, the light guide plate 3 itself is allowed to equivalently function as the parallax barrier where the scattering regions 31 act as the openings (slit portions) for the first illumination light L2 from the first light sources 2. This results in display equivalent to three-dimensional display utilizing the parallax barrier system where the parallax barrier is disposed on the back side of the display section 1.

In contrast, for display in the two-dimensional display mode (FIG. 4B), the display section 1 displays an image based on two-dimensional image data, and the polymer diffuser plate 5 is entirely switched into the diffusing-transmission mode. In this state, the first illumination light L1 from each first light source 2 is repeatedly and internally total-reflected between the first internal reflection face 3A and the second internal reflection face 3B in the light guide plate 3, thereby the first illumination light L1 is guided from the first side face, on which one of the first light sources 2 is disposed, to the opposite second side face, and allowed to exit through the second side face. In addition, part of the first illumination light L2 from the first light source 2 is scatter-reflected by the scattering regions 31 of the light guide plate 3 and thus transmitted by the first internal reflection face 3A of the light guide plate 3, and allowed to exit to the outside of the light guide plate 3. The light rays exiting to the outside through the scattering regions 31 enter the polymer diffuser plate 5. Here, the polymer diffuser plate 5 is entirely diffuse-transmissive; hence, the light rays incident on the display section 1 are diffused over the entire surface by the polymer diffuser plate 5. As a result, the light source device as a whole functions as a planar light source similar to a typical backlight. This results in display equivalent to two-dimensional display utilizing the backlight system where the typical backlight is disposed on the back side of the display section 1.

[Effect]

The display of the embodiment principally demonstrates the effects similar to those in the first embodiment though it is different in a configuration from the display of the first embodiment in that the polymer diffuser plate 5 is provided in place of the second light source 7 in the display shown in FIGS. 1 and 2.

### Fourth Embodiment

A display according to a fourth embodiment of the disclosure is now described. It is to be noted that substantially the same components as those of the displays according to the first to third embodiments are designated by the same numerals, and description of them is appropriately omitted.

[Overall Configuration of Display]

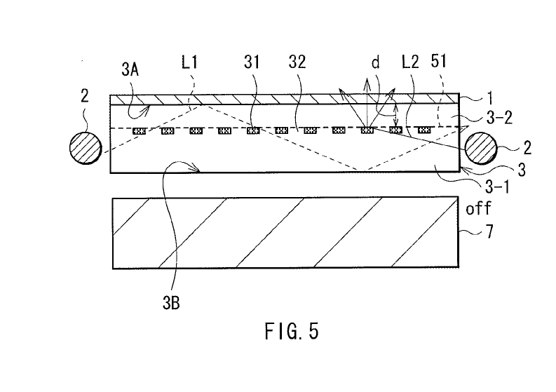

FIG. 5 illustrates an exemplary configuration of a display according to a fourth embodiment of the disclosure. The display is appropriately and selectively switched between the two-dimensional display mode and the three-dimensional display mode, as in the display shown in FIGS. 1 and 2. FIG. 5 schematically illustrates a configuration in the three-dimensional display mode together with a state of light rays emitted from a light source device.

In the embodiment, the light guide plate 3 includes a first member 3-1 and a second member 3-2 attached to each other, the members having the same optical characteristics. The scattering regions 31 are formed on the surface of the first member 3-1 through laser processing or sandblasting processing, for example.

For example, the first member 3-1 and the second member 3-2 include the same material. For attaching the members, a gel enabling optical junction (for example, OPTαGEL available from Taica Corporation) may be used for an adhesion layer 51. Alternatively, for example, in the case where acrylic resin is used as the material of the first member 3-1 and the second member 3-2, use of a one-component acrylic adhesive having substantially the same refractive index as that of the acrylic resin also enables the optical junction.

[Operation and Effect of Display]

The display of the embodiment principally demonstrates display operation (control operation of the light sources) and effects similar to those in the first embodiment though it is different in a configuration from the display of the first embodiment in that the light guide plate 3 includes the two members attached to each other. In the embodiment, the second member 3-2 of the light guide plate 3 allows to adequately maintain the distance d between the plurality of scattering regions 31 corresponding to the parallax barrier and the display section 1.

### Fifth Embodiment

A display according to a fifth embodiment of the disclosure is now described. It is to be noted that substantially the same components as those of the displays according to the first to fourth embodiments are designated by the same numerals, and description of them is appropriately omitted.

[Overall Configuration of Display]

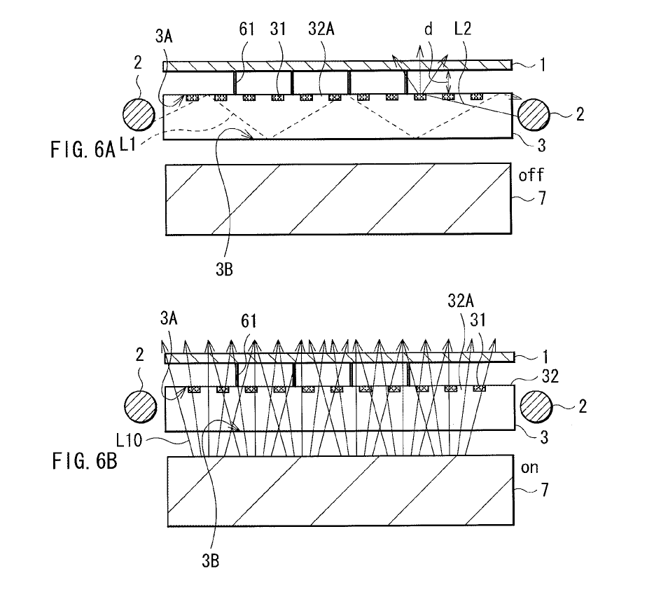

FIGS. 6A and 6B illustrate an exemplary configuration of a display according to a fifth embodiment of the disclosure. The display is allowed to be appropriately and selectively switched between the two-dimensional display mode and the three-dimensional display mode, as in the display shown in FIGS. 1 and 2. FIG. 6A schematically illustrates a configuration in the three-dimensional display mode, and FIG. 6B schematically illustrates a configuration in the two-dimensional display mode. FIGS. 6A and 6B each also schematically illustrate a state of light rays emitted from a light source device in each display mode.

In the embodiment, scattering regions 31 are provided on a first internal reflection face 3A of a light guide plate 3. In the first internal reflection face 3A, the regions other than the scattering regions 31 act as total reflection regions 32A. For example, the scattering regions 31 are formed on the first internal reflection face 3A of the light guide plate 3 through laser processing or sandblasting processing. On the first internal reflection face 3A, the scattering regions 31 function as the openings (slit portions) of the parallax barrier and the total reflection regions 32A function as the light-shielding portions thereof, during the three-dimensional display mode. Specifically, the first internal reflection face 3A has a structure corresponding to the parallax barrier.

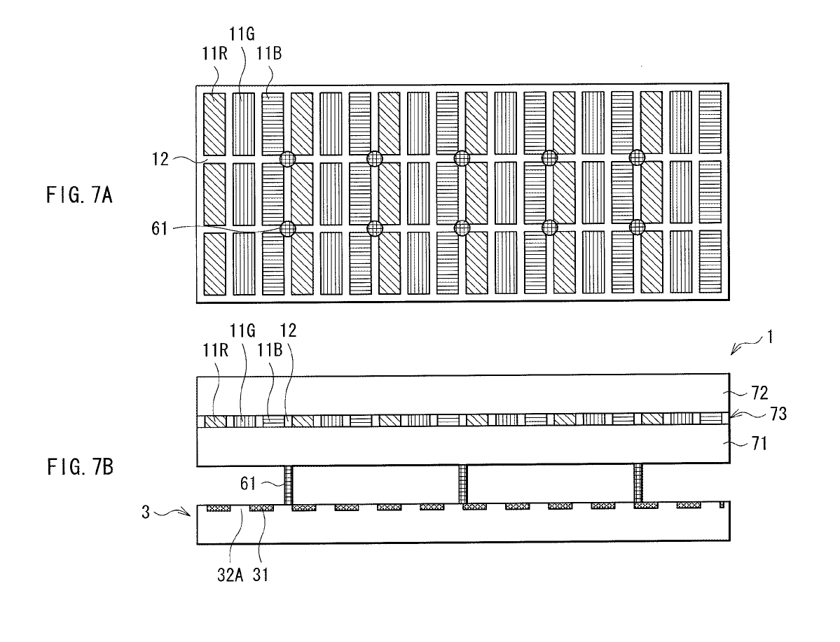

In the embodiment, posts 61 are provided as supports between the light guide plate 3 and the display section 1. The disposed positions of the posts 61 are now described with reference to FIGS. 7A and 7B. As shown in FIG. 7B, the display section 1 includes a first transparent substrate 71, a second transparent substrate 72, and a pixel region 73. As shown in FIG. 7A, the pixel region 73 includes a plurality of pixels, each including a red (R) sub-pixel 11R, a green (G) sub-pixel 11G, and a blue (B) sub-pixel 11B, arranged in a matrix. A black matrix 12 is disposed between the pixels.

As shown in FIGS. 7A and 7B, the posts 61 are disposed at positions in a region corresponding to the black matrix 12 so as to have less influence on display. Each post 61 preferably has a shape with a size smaller than the size of the black matrix 12. Only one post 61 may be provided at the center of the screen, or two or more posts 61 that satisfy the above-described condition may be provided. While the posts 61 are arranged at positions in the region corresponding to the black matrix 12 in a horizontal direction in the example shown in FIG. 7A, the posts 61 may be arranged in a vertical direction. If the width of the black matrix 12 is different between the horizontal and vertical directions, the posts 61 are preferably arranged in a direction corresponding to a larger width.

Each post 61 includes a member separate from the light guide plate 3 and the display section 1, and is adherently fixed to the light guide plate 3 or the display section 1. Alternatively, protrusive posts may be provided on the light guide plate 3 instead of the separate members. In such a case, the protrusive posts 61 are not necessarily formed by integral molding, and may be formed by applying a thick film on the light guide plate 3, and then patterning the thick film to allow only the portions corresponding to the posts 61 to be left, for example.

[Operation and Effect of Display]

The display of the embodiment principally demonstrates the display operation (control operation of the light sources) and the effects on display similar to those in the first embodiment though it is different from the display of the first embodiment in positions where the scattering regions 31 are provided, and in the configuration of the posts 61 are provided. In the embodiment, the posts 61 allows the distance d between the plurality of scattering regions 31 corresponding to the parallax barrier and the display section 1 to be adequately maintained.

### Other Embodiments

The technology according to the present disclosure is not limited to the above-described embodiments, and various modifications or alterations of the technology may be made. For example, while the fifth embodiment has been described with the exemplary configuration where the scattering regions 31 and the total reflection regions 32A are provided only on the first internal reflection face 3A of the light guide plate 3, the scattering regions 31 and the total reflection regions 32A may be provided on the second internal reflection face 3B. Alternatively, the scattering regions 31 and the total reflection regions 32A may be provided on both the first internal reflection face 3A and the second internal reflection face 3B.

It is possible to achieve at least the following configurations from the above-described example embodiments and the modifications of the disclosure.

(1) A light source device including:

a light guide plate having a first internal reflection face and a second internal reflection face opposed to each other;

a first light source applying first illumination light into the light guide plate through a side face thereof; and

a plurality of scattering regions provided, inside the light guide plate, between the first internal reflection face and the second internal reflection face, the scattering regions allowing the first illumination light to be scattered and to exit from the first internal reflection face to outside of the light guide plate.

(2) The light source device according to (1), further including

a second light source disposed to face the second internal reflection face of the light guide plate and to externally apply second illumination light to the second internal reflection face.

(3) The light source device according to (1) or (2), wherein

the light guide plate includes a first member and a second member attached to each other, the first member having an optical property same as that of the second member.

(4) The light source device according to any one of (1) to (3), further including

an optical device disposed to face the second internal reflection face of the light guide plate, and allowed to be selectively switched, in a mode of action on incident light rays, between a light absorption mode and a scattering-reflection mode.

(5) The light source device according to any one of (1) to (3), further including

an optical device disposed to face the first internal reflection face of the light guide plate, and allowed to be selectively switched, in a mode of action on incident light rays, between a transparent mode and a diffusing-transmission mode.

(6) A display including:

a display section displaying image; and

a light source device emitting light for image display to the display section,

wherein the light source device includes

a light guide plate having a first internal reflection face and a second internal reflection face opposed to each other,

a first light source applying first illumination light into the light guide plate through a side face thereof, and

a plurality of scattering regions provided, inside the light guide plate, between the first internal reflection face and the second internal reflection face, the scattering regions allowing the first illumination light to be scattered and to exit from the first internal reflection face to outside of the light guide plate.

(7) The display according to (6), further including

a second light source disposed to face the second internal reflection face of the light guide plate and externally apply second illumination light to the second internal reflection face.

(8) The display according to (7), wherein

the display section selectively switches images to be displayed between a plurality of perspective images based on three-dimensional image data and an image based on two-dimensional image data, and

the second light source is controlled to stay unlit when the plurality of perspective images are displayed on the display section, and controlled to stay lit when the image based on the two-dimensional image data is displayed on the display section.

(9) The display according to (8), wherein

the first light source is controlled to stay lit when the plurality of perspective images are displayed on the display section, and controlled to stay unlit or lit when the image based on the two-dimensional image data is displayed on the display section.

(10) A display including:

a display section displaying image; and

a light source device emitting light for image display to the display section,

wherein the light source device includes

a light guide plate having a first internal reflection face and a second internal reflection face opposed to each other;

a first light source applying first illumination light into the light guide plate through a side face thereof;

a support provided between the light guide plate and the display section; and

a plurality of scattering regions provided on one or both of the first and second internal reflection faces, the scattering regions allowing the first illumination light from the first light source to be scattered and to exit from the first internal reflection face to outside of the light guide plate.

(11) The display according to (10) wherein

the display section includes:

a plurality of pixels; and

a black matrix provided between the plurality of pixels, the support being provided in part or all of a region corresponding to the black matrix.

(12) A display including:

a display section; and

a light source device including a light guide plate, a first light source, and a second light source, wherein

the light guide plate has a first face and a second face opposed to each other and includes a plurality of scattering regions provided between the first and second faces,

the first light source is disposed to face a side of the light guide plate,

the second light source is disposed to face a second side of the light guide plate,

the display section is disposed to face the first face, and has a first display mode and a second display mode,

the first light source is controlled to stay lit whereas the second light source is controlled to stay unlit, in the first display mode, and

the second light source is controlled to stay lit in the second display mode.

(13) The display according to (12), wherein

the first display mode allows a plurality of perspective images based on three-dimensional image data to be displayed, and

the second display mode allows display of an image based on two-dimensional image data to be displayed.

The present disclosure contains subject matter related to that disclosed in Japanese Priority Patent Application JP 2011-126087 filed in the Japan Patent Office on Jun. 6, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light source device comprising:
a light guide plate having a first internal reflection face and a second internal reflection face opposed to each other;
a first light source applying first illumination light into the light guide plate through a side face thereof; and
a plurality of scattering regions provided, inside the light guide plate, between the first internal reflection face and the second internal reflection face, the scattering regions allowing the first illumination light to be scattered and to exit from the first internal reflection face to outside of the light guide plate.

2. The light source device according to claim 1, further comprising
a second light source disposed to face the second internal reflection face of the light guide plate and to externally apply second illumination light to the second internal reflection face.

3. The light source device according to claim 1, wherein
the light guide plate includes a first member and a second member attached to each other, the first member having an optical property same as that of the second member.

4. The light source device according to claim 1, further comprising
an optical device disposed to face the second internal reflection face of the light guide plate, and allowed to be selectively switched, in a mode of action on incident light rays, between a light absorption mode and a scattering-reflection mode.

5. The light source device according to claim 1, further comprising
an optical device disposed to face the first internal reflection face of the light guide plate, and allowed to be selectively switched, in a mode of action on incident light rays, between a transparent mode and a diffusing-transmission mode.

6. A display comprising:
a display section displaying image; and
a light source device emitting light for image display to the display section,
wherein the light source device includes
a light guide plate having a first internal reflection face and a second internal reflection face opposed to each other,
a first light source applying first illumination light into the light guide plate through a side face thereof, and
a plurality of scattering regions provided, inside the light guide plate, between the first internal reflection face and the second internal reflection face, the scattering regions allowing the first illumination light to be scattered and to exit from the first internal reflection face to outside of the light guide plate.

7. The display according to claim 6, further comprising
a second light source disposed to face the second internal reflection face of the light guide plate and externally apply second illumination light to the second internal reflection face.

8. The display according to claim 7, wherein
the display section selectively switches images to be displayed between a plurality of perspective images based on three-dimensional image data and an image based on two-dimensional image data, and
the second light source is controlled to stay unlit when the plurality of perspective images are displayed on the display section, and controlled to stay lit when the image based on the two-dimensional image data is displayed on the display section.

9. The display according to claim 8, wherein
the first light source is controlled to stay lit when the plurality of perspective images are displayed on the display section, and controlled to stay unlit or lit when the image based on the two-dimensional image data is displayed on the display section.

10. A display comprising:
a display section displaying image; and
a light source device emitting light for image display to the display section,
wherein the light source device includes
a light guide plate having a first internal reflection face and a second internal reflection face opposed to each other;
a first light source applying first illumination light into the light guide plate through a side face thereof;
a support provided between the light guide plate and the display section; and
a plurality of scattering regions provided on one or both of the first and second internal reflection faces, the scattering regions allowing the first illumination light from the first light source to be scattered and to exit from the first internal reflection face to outside of the light guide plate.

11. The display according to claim 10 wherein
the display section includes:
a plurality of pixels; and
a black matrix provided between the plurality of pixels, the support being provided in part or all of a region corresponding to the black matrix.

12. A display comprising:
a display section; and
a light source device including a light guide plate, a first light source, and a second light source, wherein
the light guide plate has a first face and a second face opposed to each other and includes a plurality of scattering regions provided between the first and second faces,
the first light source is disposed to face a side of the light guide plate, the second light source is disposed to face a second side of the light guide plate,
the display section is disposed to face the first face, and has a first display mode and a second display mode,
the first light source is controlled to stay lit whereas the second light source is controlled to stay unlit, in the first display mode, and
the second light source is controlled to stay lit in the second display mode.

13. The display according to claim 12, wherein
the first display mode allows a plurality of perspective images based on three-dimensional image data to be displayed, and
the second display mode allows display of an image based on two-dimensional image data to be displayed.
